(19) United States
(12) Patent Application Publication
(10) Pub. No.: US 2008/0169767 A1
(43) Pub. Date: Jul. 17, 2008

(54) Driver circuit having power factor correction function implemented with sinusoidal waveform method

(75) Inventors: Ying-Nan Cheng, Taipei Hsien (TW); Kuang-Ming Wu, Taipei Hsien (TW)

Correspondence Address: Joe McKinney Muncy, PO Box 1364, Fairfax, VA, 22038-1364, US

(73) Assignee: Zippy Technology Corp.

(21) Appl. No.: 11/652,697

(22) Filed: Jan. 12, 2007

(51) Int. Cl. H05B 41/14; H02M 3/335

(52) U.S. Cl. 315/200 R; 363/21.01

(57) ABSTRACT

The present invention discloses a driver circuit having a power factor correction function implemented with a sinusoidal waveform method and comprises the following components: a rectification unit receiving the alternating periodical signal of a commercial power and transforming the signal into a direct-current pulse signal with a positive-semiperiod sinusoidal waveform; a control unit receiving the direct-current pulse signal of the rectification unit as a level signal and determining a power conduction cycle signal of the output power according to the direct-current pulse signal; a driver unit receiving the power conduction cycle signal of the control unit and a direct-current power signal and dividing the direct-current power signal into a plurality of continuous voltage pulse signals according to the power turn-on period signal; and a transformer unit receiving the direct-current power signals in response to the respective voltage pulse signals and outputting a voltage to drive the load according to the voltage of each voltage pulse signal.

### FIELD OF THE INVENTION

The present invention relates to a driver circuit, particularly to a driver circuit having a power factor correction function implemented with a sinusoidal waveform method.

### BACKGROUND OF THE INVENTION

Among the loads connected to a general AC power distribution system of a commercial power company, most of them have the components of resistance and inductance except pure resistive loads, such as incandescent lamps and electric ovens. Therefore, the phase angle usually lags behind the voltage in the circuit of a general electric device. The current generated by the generators and supplied via a transmission/distribution system may be divided into an active component and a reactive component. As the rated voltages of loads are different, the kilowatt-hour meter on the client side only calculates the active power (KW) but ignores the reactive component. However, reactive power (KVAR) correlates with voltage drop and power loss. No matter for a commercial power company or a client, reactive power is a loss. Therefore, how to achieve an effective power factor correction is a subject seriously concerned by the manufactures of the electric systems of the client side.

The, power factor correction technology, including the active type and the passive type, can reduce power loss, improve power quality, increase load lifetime, and decrease power expense. Some conventional driver circuits adopt a valley-fill power factor correction technology. Refer to FIG. 1 a diagram schematically showing a conventional driver circuit and FIG. 2 a diagram schematically showing the waveform output by the conventional driver circuit. The conventional driver circuit comprises a rectification unit A1, a switch unit A3 and a valley-fill power factor correction circuit A2, wherein the rectification unit A1 transforms an input AC periodical signal into a DC periodical signal; the witch unit A3 divides the driving power to be output the rear-end loads (such as hot cathode fluorescent lamps A4) and has a working voltage; the valley-fill power factor correction circuit A2 is coupled to the rectification unit A1 and has a cut-off voltage Va, and the cut-off voltage Va is higher that the working voltage of the switch unit A3. Thus, the rectification unit A1 will turn off when the voltage of the input AC periodical signal is lower than the cut-off voltage Va lest the electricity accumulated in the input end of the switch unit A3 damage the input end or penetrate the switch unit A3.

The abovementioned driver circuit can prevent the electricity accumulated in the input end of the switch unit A3 from damaging the input end or penetrating the switch unit A3. However, the abovementioned driver circuit cannot always output a complete waveform, which makes the rear-end loads (such as hot cathode fluorescent lamps A4) turn off when the voltage of the input AC periodical signal is lower than the cut-off voltage Va. Therefore, the Inventor has been devoted to the related research and proposes the present invention that outputs a complete waveform to enable the rear-end loads to operate persistently.

### SUMMARY OF THE INVENTION

The primary objective of the present invention is to utilize a positive-semiperiod sinusoidal pulse signal to modulate the pulse width of the duty cycle to enable a load to persistently operate with a full sinusoidal waveform signal.

To achieve the abovementioned objective, the present invention proposes a driver circuit having a power factor correction function implemented with a sinusoidal waveform method, which can fully utilize the active power of a commercial power to drive a load and accomplish a power factor correction effect and comprises the following components: a rectification unit, a control unit, a driver unit and a transformer unit. The rectification unit receives the alternating periodical signal of a commercial power and transforms the signal into a direct-current pulse signal with a positive-semiperiod sinusoidal waveform. The control unit receives the direct-current pulse signal of the rectification unit as a level signal and determines a power conduction cycle signal of the output power according to the amplitude of the direct-current pulse signal. The driver unit receives the power conduction cycle signal of the control unit and a direct-current power signal and divides the direct-current power signal into a plurality of continuous voltage pulse signals according to the power conduction cycle signal. The transformer unit receives the direct-current power signals in response to the respective voltage pulse signals and outputs a voltage to drive the load according to the voltage of each voltage pulse signal.

### BRIEF DESCRIPTION OF THE DRAWINGS

FIG. 1 is a diagram schematically showing a conventional driver circuit.

FIG. 2 is a diagram schematically showing the waveform output by a conventional driver circuit.

FIG. 3 is a block diagram schematically showing a preferred embodiment of the present invention.

FIG. 4 is a diagram schematically showing the waveform of an alternating sinusoidal periodical signal according to a preferred embodiment of the present invention.

FIG. 5 is a diagram schematically showing the waveform of a first direct-current pulse signal according to a preferred embodiment of the present invention.

FIG. 6 is a diagram schematically showing the waveform of a second direct-current pulse signal according to a preferred embodiment of the present invention.

FIG. 7 is a diagram schematically showing the working principle of the control unit according to a preferred embodiment of the present invention.

FIG. 8 is a diagram schematically showing the waveform of a direct-current power signal according to a preferred embodiment of the present invention.

FIG. 9 is a diagram schematically showing the waveform of a voltage pulse signal according to a preferred embodiment of the present invention.

FIG. 10 is a diagram schematically showing the waveform of an alternating sinusoidal signal according to a preferred embodiment of the present invention.

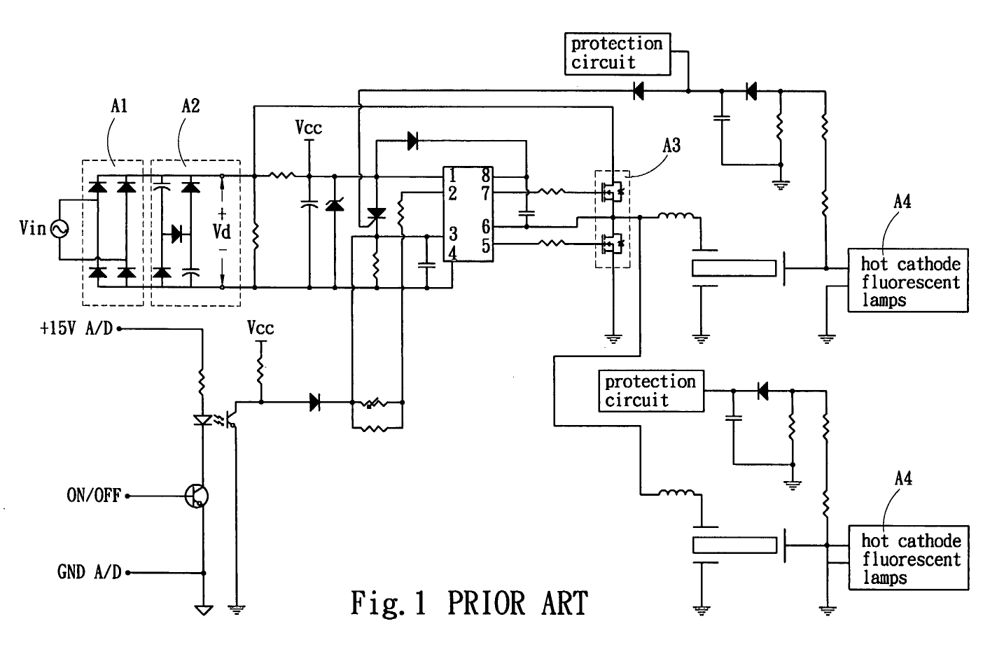

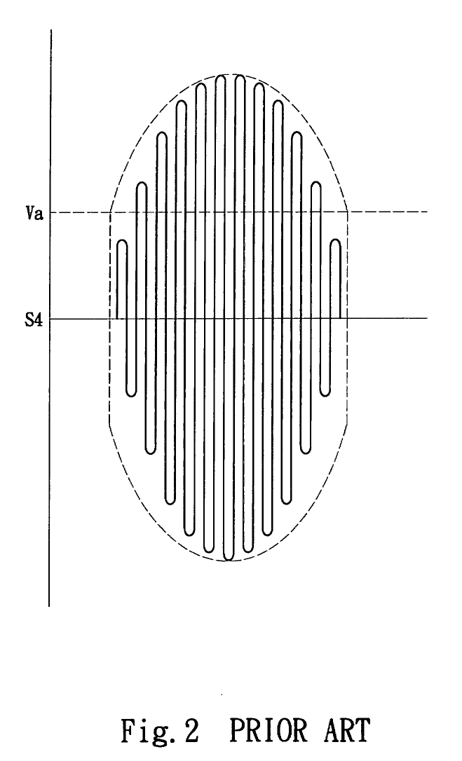

### DETAILED DESCRIPTION OF THE PREFERRED EMBODIMENTS

The technical contents of the present invention are to be described in detail in cooperation with the drawings below.

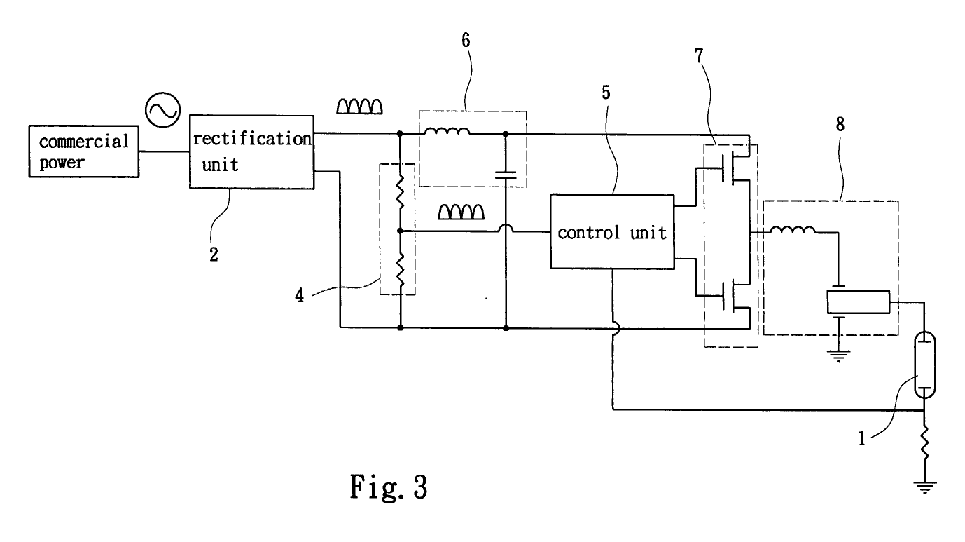

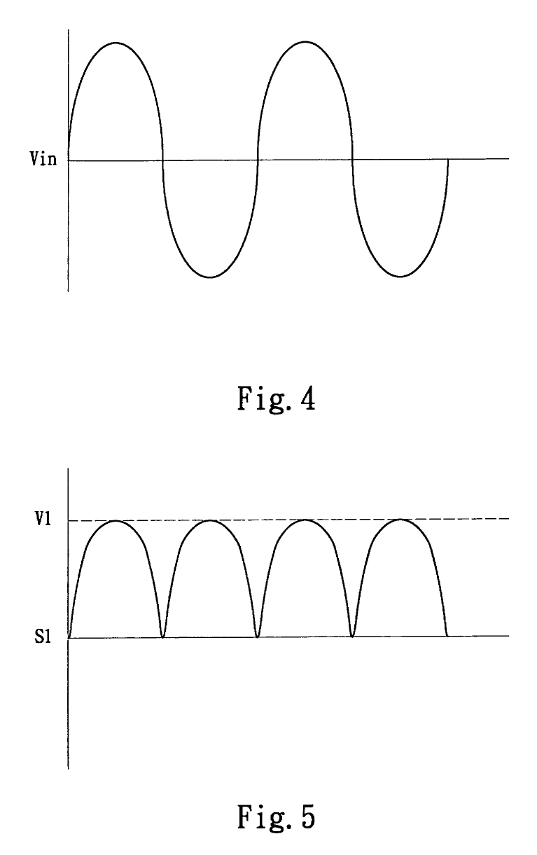

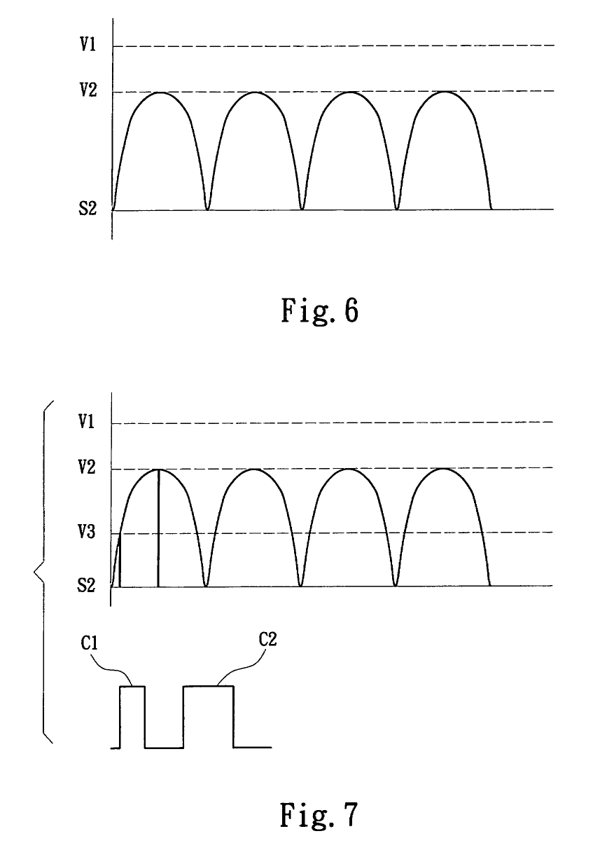

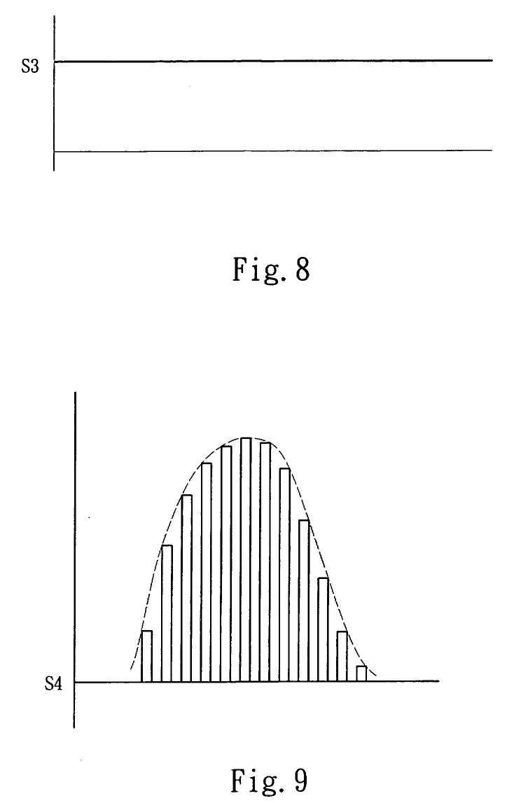

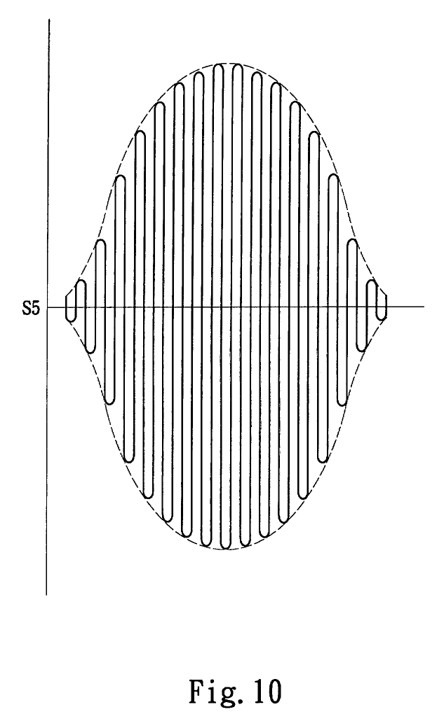

Refer to the following figures demonstrating the present invention: FIG. 3 a block diagram schematically showing a preferred embodiment, FIG. 4 a diagram schematically showing the waveform of an alternating sinusoidal periodical signal, FIG. 5 a diagram schematically showing the waveform of a first direct-current pulse signal, FIG. 6 a diagram schematically showing the waveform of a second direct-current pulse signal, FIG. 7 a diagram schematically showing the working principle of the control unit, FIG. 8 a diagram schematically showing the waveform of a direct-current power signal, FIG. 9 a diagram schematically showing the waveform of a voltage pulse signal, and FIG. 10 a diagram schematically showing the waveform of an alternating sinusoidal signal. The present invention pertains to a driver circuit having a power factor correction function implemented with a sinusoidal waveform method, wherein the driver circuit can fully utilize the active power of a commercial power to drive a load 1 and achieve the power factor correction effect. In this embodiment, the load 1 is a gas discharge lamp, and the frequency of the commercial power is 60 Hz.

The driver circuit of the present invention comprises the following components:

a rectification unit 2 receiving the alternating sinusoidal periodical signal Vin of a commercial power and transforming the signal Vin into a first direct-current pulse signal S1 with a positive-semiperiod sinusoidal waveform, wherein in this embodiment, the rectification unit 2 is a full-wave rectifier, and the frequency of the first direct-current pulse signal S1 is 120 Hz;

a voltage division unit 4 receiving and voltage-dividing the first direct-current pulse signal S1 of the rectification unit 2 to output a second direct-current pulse signal S2, wherein the maximum amplitude of the second direct-current pulse signal S2 is smaller than the maximum amplitude of the first direct-current pulse signal S1, and wherein in this embodiment, the voltage division unit 4 further comprises two resistors that are cascaded to each other;

a control unit 5 receiving the second direct-current pulse signal S2 of the voltage division unit 4 as a level signal (i.e. the light-adjusting signal of the gas discharge lamp) and determining a power turn-on period signal of the output power and receiving a feedback signal of the load 1, wherein the control unit 5 determines the conduction cycle of the power conduction cycle signal of the output power according to the amplitude of the second direct-current pulse signal S2 and then determines the driving current of the load 1, wherein in this embodiment, the control unit 5 is a PWM (Pulse Width Modulation) controller; (For example, as shown in FIG. 7, the amplitude V2 of the second direct-current pulse signal S2 determines that the conduction cycle of the power conduction cycle signal is C1, and the amplitude V3 of the second direct-current pulse signal S2 determines that the conduction cycle of the power conduction cycle signal is C2; the voltage division unit 4 performs voltage division to obtain the second direct-current pulse signal S2 suitable for the control unit 5 according to the range of the working voltage of the control unit 5.)

a filter unit 6 receiving and filtering the first direct-current pulse signal S1 of the rectification unit 2 to output a direct-current power signal S3, wherein in this embodiment, the filter unit 6 further comprises an inductor and a filter capacitor that transform the first direct-current pulse signal S1;

a driver unit 7 receiving the power conduction cycle signal of the control unit 5 and the direct-current power signal S3 of the filter unit 6 and dividing the direct-current power signal S3 into a plurality of continuous voltage pulse signals S4 according to the power conduction cycle signal, wherein in this embodiment, the driver unit 7 is a biswitch; and (A maintaining voltage is still offered in the off state of the power conduction cycle signal. However, the maintaining voltage does not influence the operation of the present invention. The factor of the maintaining voltage is ignored to achieve the consistency of the specification lest the Examiners be confused.)

a transformer unit 8 receiving the direct-current power signals S3 in response to the respective voltage pulse signals S4 and outputting a voltage to drive the load 1 according to the voltage of each voltage pulse signal S4, wherein in this embodiment, the transformer unit 8 further comprises a ceramic PZT (piezoelectric) element and an inductor element at the front of the PZT element, and the voltage output by the transformer unit 8 is an alternating sinusoidal signal S5.

In summary, the present invention adopts a positive-semiperiod sinusoidal direct-current pulse signal as a level signal of the control unit 5 and modulates the pulse width of the duty cycle according to the amplitude of the direct-current pulse signal and then determines the driving power of the rear-end load 1. Thereby, the rear-end load 1 can full acquire the power output by the driver circuit to operate persistently. Thus, the present invention can overcome the conventional problem that the driving cannot continuously drive the rear-end load 1 because of the cut-off voltage Va of the conventional valley-fill power factor correction circuit. Consequently, the driver circuit of the present invention can fully utilize the active power of a commercial power to drive the load 1 and achieve the power factor correction effect. Therefore, the present invention indeed possesses novelty and non-obviousness and meets the requirements of a patent. Thus, the Inventors file the application for a patent. It is to be greatly appreciated that the patent be approved fast.

Those described above are the preferred embodiments to exemplify the present invention. However, it is not intended to limit the scope of the present invention. Any equivalent modification or variation according to the spirit of the present invention is to be also included within the scope of the present invention.

What is claimed is:

1. A driver circuit having a power factor correction function implemented with a sinusoidal waveform method, which can fully utilize the active power of a commercial power to drive a load and achieve a power factor correction effect, comprising:
a rectification unit receiving the alternating periodical signal of a commercial power and transforming said signal into a direct-current pulse signal with a positive-semiperiod sinusoidal waveform;
a control unit receiving said direct-current pulse signal of said rectification unit as a level signal and determining a power conduction cycle signal of the output power according to the amplitude of said direct-current pulse signal;
a driver unit receiving said power conduction cycle signal of said control unit and a direct-current power signal and dividing said direct-current power signal into a plurality of continuous voltage pulse signals according to said power conduction cycle signal; and
a transformer unit receiving said direct-current power signals in response to the respective said voltage pulse signals and outputting a voltage to drive said load according to the voltage of each said voltage pulse signal.

2. The driver circuit having the power factor correction function implemented with said sinusoidal waveform method according to claim 1, wherein said rectification unit is a full-wave rectifier.

3. The driver circuit having the power factor correction function implemented with said sinusoidal waveform method according to claim 1, wherein said control unit is a PWM (Pulse Width Modulation) controller.

4. The driver circuit having the power factor correction function implemented with said sinusoidal waveform method according to claim 1, wherein said control unit determines the conduction cycle of said power conduction cycle signal of the output power according to the amplitude of said direct-current pulse signal.

5. The driver circuit having the power factor correction function implemented with said sinusoidal waveform method according to claim 1, wherein the front end of said driver unit is coupled to a filter unit, and said filter unit receives and filters said direct-current pulse signal of said rectification unit to output said direct-current power signal to said driver unit.

6. The driver circuit having the power factor correction function implemented with said sinusoidal waveform method according to claim 1, wherein said filter unit further comprises an inductor and a filter capacitor that transform said direct-current pulse signal.

7. The driver circuit having the power factor correction function implemented with said sinusoidal waveform method according to claim 1, wherein said driver unit is a biswitch.

8. The driver circuit having the power factor correction function implemented with said sinusoidal waveform method according to claim 1, wherein a voltage division unit is installed between said rectification unit and said control unit, and said voltage division unit receives and voltage-divides said direct-current pulse signal of said rectification unit and then outputs the processed signal to said control unit.

9. The driver circuit having the power factor correction function implemented with said sinusoidal waveform method according to claim 1, wherein said load is a gas discharge lamp.
